(19) United States
(12) Patent Application Publication
(10) Pub. No.: US 2024/0237116 A9
(43) Pub. Date: Jul. 11, 2024

(54) METHODS AND DEVICES FOR MANAGING DATA TRAFFIC IN A WIRELESS COMMUNICATION SYSTEM

(71) Applicant: Samsung Electronics Co., Ltd., Suwon-si (KR)

(72) Inventors: Pavan Kumar DEVARAYANIGARI, Bengaluru (IN); Rohit KUMAR, Bengaluru (IN); Shalini GOVIL, Bengaluru (IN); Pushpa RAMU, Bengaluru (IN)

(73) Assignee: Samsung Electronics Co., Ltd., Suwon-si (KR)

(21) Appl. No.: 18/303,186

(22) Filed: Apr. 19, 2023

(30) Foreign Application Priority Data
Oct. 20, 2022 (IN) 202241060023

(51) Int. Cl. H04W 76/19; H04L 5/00

(52) U.S. Cl. CPC H04W 76/19; H04L 5/0053; H04W 80/06

(57) ABSTRACT

Embodiments herein disclose methods and devices for managing data traffic on a receiver. A method disclosed herein includes detecting, by a receiver, at least one out of order radio link control (RLC) protocol data unit (PDU) in a plurality of RLC PDUs received from a transmitter, performing, by the receiver, a recovery action based on a Packet Data Convergence Protocol (PDCP) reordering time to recover the at least one out of order RLC PDU; and causing, by the receiver, an RLC layer to send a plurality of RLC service data units (SDUs) to a higher layer after the performing the recovery action, the plurality of RLC SDUs corresponding to the plurality of RLC PDUs.

This application claims priority to Indian Patent Application No. 202241060023, filed on Oct. 20, 2022, and all the benefits accruing therefrom under 35 U.S.C. § 119, the disclosure of which is incorporated herein by reference in its entirety.

The following specification particularly describes and ascertains the nature of the inventive concepts and the manner in which they may be performed.

### TECHNICAL FIELD

The present disclosure relates to the field of wireless communication systems and more particularly to managing data traffic on a receiver at different user-plane entities/layers.

### BACKGROUND

Wireless communication systems may be widely deployed to provide various types of communication services such as, but not limited to, voice, video, packet data, messaging, broadcast, and so on. In a wireless communication system, a receiver (such as, a Base Station (BS), a User Equipment (UE), or the like) may utilize multiple protocols to process data received from a transmitter (such as, another BS, a core network/network, or the like). The multiple protocols may include a Packet Data Convergence Protocol (PDCP) layer for header compression and sequencing, a radio link control (RLC) layer for error correction and segmentation/concentration of packets, and a medium access control (MAC) layer for multiplexing and error correction.

In conventional approaches, in the receiver, the PDCP layer receives Protocol Data Units (PDUs) including data from the RLC layer. If the received PDUs are out of order PDUs (e.g., the received PDUs are not in a correct sequence), the PDCP layer initiates a PDCP reordering timer (PDCP_Reorder_Timer) and waits for reception of missing PDUs. If the PDCP layer does not receive the missing PDUs, on an expiry of the PDCP reordering timer, the PDCP layer updates PDCP state variables (for example: RX_DELIV) to a next sequence of PDUs (e.g., showing no more interest in the reception of the missing PDUs). However, RLC state variables (for example: VR_R or RX_Next) of the RLC layer become stuck (e.g., are unable to update) at the receiver due to attempts to recover the missing PDUs from the transmitter. As an out of order delivery is built at the RLC layer and the RLC layer supports Automatic Repeat Request (ARQ) transmission, the RLC layer continuously sends ARQ requests to the transmitter for the reception of the missing PDUs. Therefore, the transmitter transmits unacknowledged (UN-Acked) PDUs to the RLC layer, which forwards the received unacknowledged PDUs to the PDCP layer. However, the PDCP layer discards the received unacknowledged PDUs as old PDUs because the PDCP state variables have been already updated. Thus, a lot of network resources may be wasted due to the RLC ARQ functionality in the event of expiry of the PDCP reordering timer.

In addition, an uplink (UL)/downlink (DL) operation for the PDUs (e.g., reception of the missing PDUs and discarding of the missing PDUs) in the event of expiry of the PDCP reordering timer results in excessive power wastage at the receiver.

Consider an example scenario, as depicted in FIG. 1A, wherein the PDCP layer receives PDU sequence numbers (SNs) of 1 2 3 4 36 37 38 from the RLC layer. The PDCP layer initiates the PDCP reordering timer, as the PDCP layer receives the missed/out of order PDU SN at 36. The PDCP layer transmits the PDU SNs 1 2 3 4 36 37 38 to a higher layer and updates the PDCP state variable (RX_DELIV) to 39, when the PDCP layer does not receive the missed PDU SNs after the expiry of the PDCP reordering timer. The RLC layer may receive the missed PDU SNs 5 6 7 8 till 35 from the transmitter, on the expiry of the PDCP reordering timer and transmit the received missed PDU SNs to the PDCP layer. However, the PDCP layer discards the missed PDU SNs received from the RLC layer as out of window, since the PDCP state variables have already been updated to 39.

Further, in the conventional approaches, if the receiver is a UE supporting multiple Subscriber Identity Modules (MUSIMs), Radio Frequency (RF) tune away effects 3GPP standard reordering time behavior, as the UE is not available during the RF tune away. In the event of the RF tune away due to the MUSIMs, the expiry of the PDCP reordering timer causes the update of the PDCP state variables and the subsequent RLC retransmission (RETX), as the RLC ARQ functionality has been discarded.

Consider an example scenario, wherein the RLC layer receives the PDU SNs of 1 2 3 4 36 37 38 and forwards the received SNs to the PDCP layer. In such a scenario, the PDCP layer initiates the PDCP reordering time, as the PDCP layer receives the missing/out of order PDU SN at 36. Due to the RF tune away, the receiver may not be available. Meanwhile, the PDCP layer sends the PDU SNs 1 2 3 4 36 37 38 to the higher layer, on the expiry of the PDCP reordering time and updates the PDCP state variables (RX_DELIV) to 39. Once the receiver resumes working (e.g., at an event of RF return), the RLC layer receives the missing PDU SNs 5 6 7 8 till 35 and sends the received missing PDU SNs to the PDCP PDU. However, the PDCP layer may discard the missing PDU SNs from the RLC layer, since the PDCP state variables have been updated to 39. Thus, resulting in wastage of network resources.

Further, in the conventional approaches, for a bearer, if the PDCP layer detects a first out of order PDU/missing PDU, the PDCP layer attempts to initiate the PDCP reordering timer despite at the respective (single/both) RLC layer there is no out of order reception. Such a situation may occur in voice call and poor signal scenarios due to a Radio Bearer (RB) modification with Unacknowledged mode (UM) of the RLC layer, with buggy implementation, or due to discard timer expiry and may affect voice quality.

Consider an example scenario, as depicted in FIG. 1B, the receiver and the transmitter are performing data exchange over an air interface. At the transmitter side, PDCP level, SN 2, 4, 5 and 7 are discarded locally (e.g., due to discard timer expiry). PDCP SN 1 is sent as RLC SN 1; PDCP SN 3 is sent as RLC SN 2; PDCP SN 6 is sent as RLC SN 3 and so forth. At the receiver side, the RLC level there are no missing SNs. All RLC SN are received in sequence and forwarded to PDCP level. At PDCP level SN miss is observed because the SNs got locally discarded on the transmitter side. The RLC layer receives the PDU SNs of 1 2 3 4 5 6 and the PDCP layer receives the PDU SNs of 13 6 8 9 10. In such a scenario, the PDCP layer initiates the PDCP reordering time at the missed/out of order PDU SN 2. On the expiry of the PDCP reordering time, the PDCP layer sends the PDU SNs of 1 3 to the TCP and updates the PDCP state variables (RX_DELIV) to 4. The PDCP layers again initiates the PDCP reordering time at 6 and the PDCP layer does not send the PDU SNs of 6 8 9 10 to the higher layer. However, there may be no RLC SN jump, still reordering is performed three times at the PDCP layer. Thus, the PDU delivery from the PDCP layer to the higher layer/application may be delayed, which further causes mute behavior in communication sessions such as a voice call.

### SUMMARY

Embodiments herein provide methods and systems for detecting and recovering at least one out of order Protocol Data Unit (PDU) on a receiver.

Embodiments herein provide methods and systems for performing a first recovery action and a second recovery action to recover the at least one out of order Radio Link Control (RLC) PDU at the RLC entity, wherein the first recovery action includes initiating a RLC packet recovery timer to recover the at least one out of order RLC PDU based on a Packet Data Convergence Protocol (PDCP) recovery time, wherein the second recovery action includes sending a number of RLC status reports to a transmitter to recover the at least one out of order RLC PDU before an expiry of the PDCP recovery time.

Embodiments herein provide methods and systems for detecting and recovering, at a PDCP entity, at least one PDCP PDU, based on a Radio Frequency (RF) tune away-time and the PDCP reordering time, if the receiver is a User Equipment (UE) supporting multiple Universal Subscriber Identity Modules (USIM).

Embodiments herein provide methods and systems for enabling the PDCP entity to deliver old PDCP PDUs received after the expiry of the PDCP reordering timer to a higher layer, if a difference between PDCP state variables and a count of the old PDCP PDUs satisfies a sequence number (SN) threshold.

Embodiments herein provide methods and systems for terminating a process of initiating a PDCP reordering timer, on detecting a reception of the at least one out of order PDCP PDU at the PDCP entity and a reception of a plurality of RLC PDUs in the correct sequence at the respective RLC entity.

Embodiments herein provide methods and systems for managing data traffic in a wireless communication system. The method disclosed herein may include detecting, by a receiver, at least one out of order radio link control (RLC) protocol data unit (PDU) in a plurality of RLC PDUs received from a transmitter, performing, by the receiver, a recovery action based on a Packet Data Convergence Protocol (PDCP) reordering time to recover the at least one out of order RLC PDU; and causing, by the receiver, an RLC layer to send a plurality of RLC service data units (SDUs) to a higher layer after the performing the recovery action, the plurality of RLC SDUs corresponding to the plurality of RLC PDUs.

Embodiments herein provide a receiver in a wireless communication system, wherein the receiver processing circuitry configured to detect at least one out of order radio link control (RLC) protocol data unit (PDU) in a plurality of RLC PDUs received from a transmitter, perform a recovery action based on a Packet Data Convergence Protocol (PDCP) reordering time to recover the at least one out of order RLC PDU, and cause an RLC layer to send a plurality of RLC service data units (SDUs) to a higher layer after performing the recovery action, the plurality of RLC SDUs corresponding to the plurality of RLC PDUs.

These and other aspects of embodiments herein will be better appreciated and understood when considered in conjunction with the following description and the accompanying drawings. It should be understood, however, that the following descriptions, while indicating embodiments and numerous specific details thereof, are given by way of illustration and not of limitation. Many changes and modifications may be made within the scope of embodiments herein without departing from the spirit thereof, and embodiments herein include all such modifications.

### BRIEF DESCRIPTION OF FIGURES

Embodiments herein are illustrated in the accompanying drawings, throughout which like reference letters indicate corresponding parts in the various figures. Embodiments herein will be better understood from the following description with reference to the drawings, in which:

FIGS. 1A and 1B are example diagrams depicting conventional methods of recovering Protocol Data Units (PDUs) with wastage of network resources and increased power consumption;

FIG. 2 depicts a wireless communication system, according to embodiments as disclosed herein;

FIG. 3 is a block diagram depicting various components of a receiver (a Base Station (BS), a User Equipment (UE), or the like) for recovering out of order PDUs, according to embodiments as disclosed herein;

FIG. 4 depicts a data traffic manager in the receiver for recovering the out of order PDUs, according to embodiments as disclosed herein;

FIG. 5 depicts an example scenario for recovery of the out of order Radio Link Control (RLC) PDUs, at an RLC entity, according to embodiments as disclosed herein;

FIG. 6 depicts another example scenario for recovery of the out of order RLC PDUs, at the RLC entity, according to embodiments as disclosed herein;

FIG. 7 depicts an example scenario for recovery of the out of order RLC PDUs, at a Packet Data Convergence Protocol (PDCP) entity, according to embodiments as disclosed herein;

FIG. 8 is an example diagram depicting an example scenario of initiating a PDCP reordering time, at the PDCP entity, according to embodiments as disclosed herein;

FIG. 9 is a flow diagram depicting a method for managing the data traffic in the wireless communication system, according to embodiments as disclosed herein;

FIG. 10 is a flow diagram depicting a method for performing a first recovery action to recover at least one out of order RLC PDU at the RLC entity, according to embodiments as disclosed herein;

FIG. 11 is a flow diagram depicting a method for performing the second recovery action to recover the at least one out of order RLC PDU at the RLC entity, according to embodiments as disclosed herein; and

FIG. 12 is a flow diagram depicting a method for recovering the at least one out of order PDCP PDU at the PDCP entity, according to embodiments as disclosed herein.

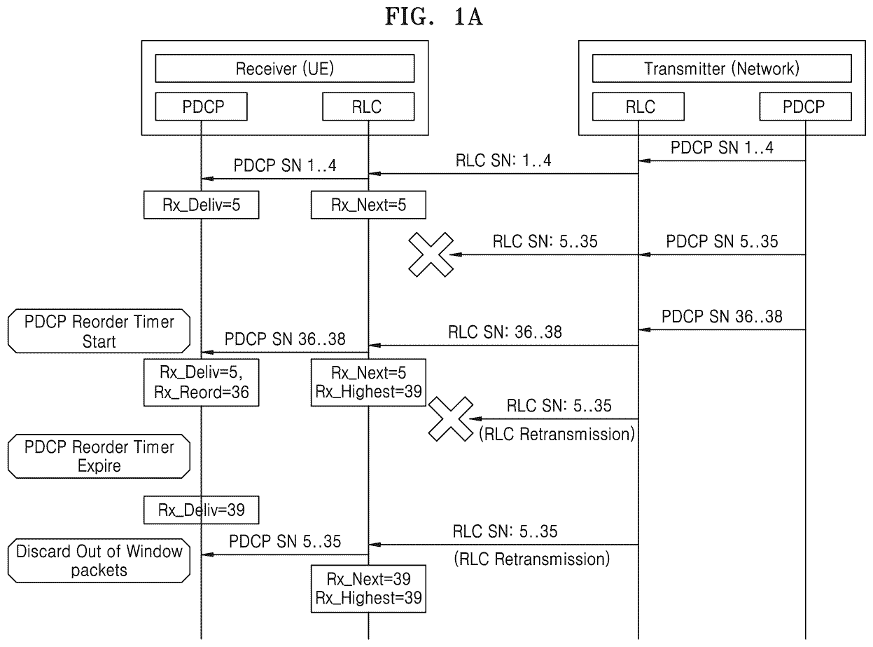

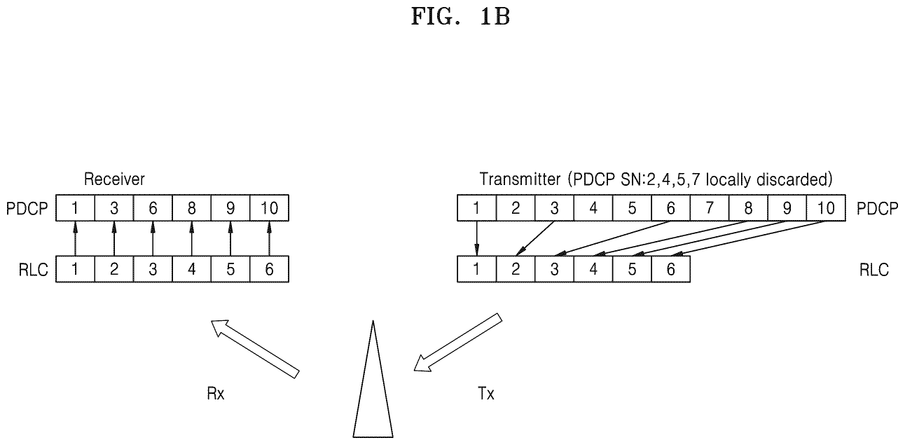

### DETAILED DESCRIPTION

Embodiments herein and the various features and advantageous details thereof are explained more fully with reference to examples that are illustrated in the accompanying drawings and detailed in the following description. Descriptions of well-known components and processing techniques may be omitted so as to not unnecessarily obscure embodiments herein. The description herein is intended merely to facilitate an understanding of ways in which embodiments herein may be practiced and to further enable those of skill in the art to practice embodiments herein. Accordingly, this disclosure should not be construed as limiting the scope of embodiments herein.

Embodiments herein disclose methods and systems for managing data traffic on a receiver at different user plane entities/layers.

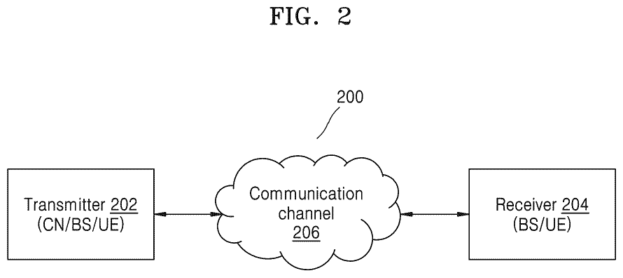

Referring now to the drawings, and more particularly to FIGS. 2 through 12, where similar reference characters denote corresponding features consistently throughout the figures, there are shown embodiments.

FIG. 2 depicts a wireless communication system 200, according to embodiments as disclosed herein. The wireless communication system 200 referred herein supports at least one Radio Access Technology (RAT) to provide communication services/sessions to User Equipments (UEs). Examples of the communication services may be, but are not limited to, a voice service session, a live streaming service session, a real time gaming service session, a buffered streaming service session, a Transport Control Protocol (TCP) based session (for example, an email, a messaging service, a file transferring service, and so on), an Internet Protocol (IP) Multimedia Subsystem (IMS) service, and so on. The wireless communication system 200 also supports multi-connectivity or dual connectivity across different Radio Access Technologies (RATs). Examples of the RATs may be, but are not limited to, a 3rd Generation Partnership Project (3GPP), a Long Term Evolution/Fourth Generation (LTE/4G), an LTE-Advanced (LTE-A), a Fifth Generation (5G) New Radio (NR), a Wireless Local Area Network (WLAN), Code Division Multiple Access (CDMA), Frequency Division Multiple Access (FDMA), Time Division Multiple Access (TDMA), Orthogonal Frequency Division Multiple Access (OFDMA), General Packet Radio Service (GPRS), Enhanced Data rates for GSM Evolution (EDGE), Universal Mobile Telecommunications System (UMTS), Enhanced Voice-Data Optimized (EVDO), High Speed Packet Access (HSPA), HSPA plus (HSPA+), Worldwide Interoperability for Microwave Access (WiMAX/IEEE 802.16), Wi-Fi (IEEE 802.11), Evolved-UTRA (E-UTRA), Wi-Fi Direct, and/or any other next generation network. In an example, the wireless communication system 200 supports an LTE Dual Connectivity (DC) (e.g., the DC is between LTE eNodeBs (eNBs)) or an NR DC (e.g., the DC is between NR gNodeBs (gNBs)). In another example, the wireless communication system 200 supports an E-UTRAN (Evolved UMTS Terrestrial Radio Access Network) New Radio-Dual Connectivity (EN DC) (e.g., the DC is between an LTE eNB and a 5G gNodeB (gNB)). In another example, the wireless communication system 200 supports a Multi-RAT DC (MR DC) (e.g., the DC is between the different RATs).

The wireless communication system 200 includes a transmitter 202 and/or a receiver 204. The transmitter 202 and the receiver 204 may communicate over a communication channel 206. Examples of the communication channel 206 may be, but are not limited to, a wired communication link, a wireless communication link, an air interface, and so on.

The transmitter 202 may be configured to transmit data/data traffic to the receiver 204 over the communication channel 206. The data referred herein may be associated with the at least one communication service/session. Examples of the transmitter 202 may be, but are not limited to, a Core Network (CN), a Base Station (BS), a User Equipment (UE), and/or any other device that is capable of transmitting the data to the receiver 204. The CN may include at least one of, a 5G Core (5GC) network, an Evolved Packet Core (EPC) and so on. The CN may be configured to connect at least one UE connected to the associated BS to an external data network. Examples of the external data network may be, but are not limited to, the Internet, a Packet Data Network (PDN), an Internet Protocol (IP) Multimedia Core Network Subsystem, and so on. The BS may include at least one of, an evolved node B (eNB), a gNodeB (gNB), and so on. The BS may be configured to connect the UE to the CN. The UE may include at least one of, but is not limited to, a mobile phone, a smartphone, a tablet, a phablet, a Personal Digital Assistant (PDA), a laptop, a computer, a wearable computing device, a vehicle infotainment device, an Internet of Things (IoT) device, a Wireless Fidelity (Wi-Fi) router, a USB dongle, and so on. The UE may support multiple Subscriber Identity Modules (MUSIMs) (hereinafter referred as a MUSIM UE) for connecting with multiple BS s of multiple RATs (e.g., for enabling the multi-connectivity).

The receiver 204 may be configured to process the data/data traffic received from the transmitter 202 over the communication channel 206 for further use. Examples of the receiver 204 may be, but are not limited to, a BS, a UE, and/or any other device that is capable of receiving and/or processing the data. In an example, the receiver 204, implemented as the BS, may receive the data from the CN or another BS (examples of the transmitter 202) and process the received data. In another example, the receiver 204, implemented as the UE, may receive the data from the BS and process the received data. The data may be associated with the at least one communication service/session. As the wireless communication system 200 supports the multi-connectivity, the receiver 204 may receive the data over a plurality of bearers such as, a Master Cell Group (MCG) bearer, a Secondary Cell Group (SCG) bearer, and/or a split bearer. A definition and a function of each bearer referred herein may be intuitively inferred by one of ordinary skill in the art by referring to 3GPP specification, and thus, its detailed description is omitted.

The receiver 204 may receive the data in a form of Protocol Data Units (PDUs). A PDU may include control information and data that has been transmitted by the transmitter 202 (e.g., user data).

The receiver 204 may support a user plane protocol to process the received PDUs. The user plane protocol may be divided into a Medium Access Control (MAC) layer/entity, a Radio Link Control (RLC) layer/entity, and/or a Packet Data Control Protocol (PDCP) layer/entity. According to embodiments, the terms layer and entity by be used interchangeably herein. The RLC entity may support data transmission modes such as, an Acknowledge mode (AM), an Unacknowledged mode (UM), and/or a Transparent Mode (TM). In the AM of the RLC entity, the receiver may use automatic repeat request (ARQ) for retransmissions, status report signaling, and/or resetting transmitting and receiving RLC entities. The RLC entity may also support segmentation and concatenation of RLC service data units (SDUs). The RLC entity may also provide transfer of upper layer PDUs supporting data transfer in the AM, the UM, and/or the TM. The RLC entity may also provide in-sequence delivery of upper layer PDUs except at handover in the uplink (UL), error correction through the ARQ, and/or duplicate detection. The PDCP entity may perform a robust header compression (ROHC) to improve transmission for latency sensitive data such as voice over IP (VoIP) and/or video telephony. The PDCP entity may provide header compression and decompression of IP data flows using the ROHC protocol. The PDCP entity may also maintain PDCP sequence numbers for radio bearers, in-sequence delivery of upper layer PDUs at a handover, and duplicate elimination of lower layer SDUs at handover for the radio bearers mapped on the RLC AM. The PDCP entity may also provide ciphering and deciphering of user plane data and control plane data, integrity protection of control plane data, and timer based discard.

In embodiments, the PDUs processed at each entity/layer may be referred using different terms through the document. The PDUs received at the RLC entity from a lower layer entity, e.g., a MAC layer, may be referred as RLC PDUs. The PDUs transmitted by the RLC entity to the PDCP entity may be referred as RLC SDUs. The PDUs received from RLC and processed at the PDCP entity may be referred as PDCP PDUs.

The receiver 204 may receive a plurality of RLC PDUs at the RLC entity and enable output (e.g., transmission) of plurality of RLC SDUs corresponding to the received plurality of RLC PDUs from the RLC entity to the PDCP entity. According to embodiments, the term “enable” as used herein may mean to cause and/or make possible. The receiver 204, at the PDCP entity may initiate a PDCP reordering timer if a plurality of PDCP PDUs corresponding to the received plurality of RLC SDUs are not in a correct sequence (e.g., in the event of a missing PDCP PDU in a sequence of received PDCP PDUs). The PDCP reordering timer may be used by the receiver 204 to recover missing PDCP PDUs. If the receiver 204 receives the missing PDCP PDUs at the PDCP entity from the RLC entity, before the expiry of the PDCP reordering timer, the receiver 204 may enable a transmission of the plurality of PDCP PDUs from the PDCP entity to a higher layer (for example: a Transport Control Protocol (TCP) layer) and update its PDCP state variables (PDCP RX_DELIV, which is a PDCP state variable). According to embodiments, the term “transmission” as used herein may refer to outputting and/or transmitting. If the receiver 204 does not receive the missing PDCP PDUs at the PDCP entity from the RLC entity before the expiry of the PDCP reordering timer, after the expiry of the PDCP reordering timer the receiver 204 may enable the transmission of the plurality of PDCP PDUs from the PDCP entity to the higher layer and update its PDCP state variables. However, in this case, if the receiver 204 receives the missing PDCP PDUs at the PDCP entity after the expiry of the PDCP reordering time, the receiver 204 at the PDCP entity may discard the missed PDCP PDUs as the receiver 204 has already updated the PDCP state variables. Thus, embodiments herein enable the receiver 204 to detect and recover the PDUs, at the RLC entity, for further processing.

In embodiments, for managing the order of the PDUs for processing, the receiver 204 at the RLC entity may receive the plurality of RLC PDUs from the transmitter 202 over at least one of, the MCG bearer, the SCG bearer, and/or the split bearer. The receiver 204 may enable the RLC entity to forward the received plurality of RLC PDUs as PDCP PDUs to the PDCP entity. The receiver 204 may initiate the PDCP reordering timer, at the PDCP entity, on detecting one or more out of order PDCP PDUs in the received plurality of PDCP PDUs from the RLC entity. On initiating the PDCP reordering timer, the receiver 204 at the RLC entity may detect one or more out of order RLC PDUs in the received plurality of RLC PDUs.

The one or more out of order RLC/PDCP PDUs may refer to one or more missing PDUs up to a first out of order PDU, which is to be transmitted to a higher layer (the PDCP entity or the TCP layer). Thus, the one or more out of order PDUs indicates that the received plurality of PDUs are not in a correct sequence. Embodiments herein use the terms “out of order PDUs”, “missing PDUs”, “sequence number (SN) gap”, and so on, interchangeably to indicate that the PDUs that are not in a correct sequence.

On detecting the one or more out of order RLC PDUs, the receiver 204, at the RLC entity, may initiate a RLC packet recovery timer, while waiting to recover (e.g., receive) the one or more RLC PDUs from the transmitter 202. The RLC packet recovery timer may be used by the receiver 204 to recover the one or more out of order RLC PDUs at the RLC entity. The receiver 204 may set a value of the RLC packet recovery time as a difference between a PDCP reordering time and a delta value; where the delta value could be zero or greater than zero. The delta value may be a UE configurable value, and may assume values in the range of 0-PDCP reordering time. The PDCP reordering time may be time value (e.g., a full time period, initial time value, and/or final time value) set for the PDCP reordering timer, which may be initiated by the receiver 204 at the PDCP entity on detecting the one or more out of PDCP PDUs at the PDCP entity. In embodiments, the CN and/or transmitter 202 may configure the PDCP reordering time for the receiver 204 to send a RLC status report to the transmitter 202. In embodiments, the receiver 204 may configure and vary the PDCP reordering time based on one or more factors such as, but are not limited to, signal conditions (e.g., a signal-to-noise ratio, a signal-to-interference-plus noise ratio, etc.), a TCP retransmission (RETX) timer value, and so on. The delta value may be at least one transmission time interval (TTI) used by the receiver 204 for delivering the RLC status report to the transmitter 202.

If the receiver 204 receives the one or more out of order RLC PDUs from the transmitter 202 before the expiry of the RLC packet recovery timer, the receiver 204 at the RLC entity may terminate the RLC packet recovery timer. On receiving the one or more out of order RLC PDUs from the transmitter 202, the receiver 204 may enable a transmission of a plurality of RLC SDUs from the RLC entity to the PDCP entity. The plurality of RLC SDUs may correspond to the plurality of RLC PDUs including the received out of order RLC PDUs (e.g., the RLC PDUs in the ordered sequence). According to embodiments, the receiver 204 at the RLC entity may receive the one or more out of order RLC PDUs from the transmitter 202 over at least one of, the MCG bearer, the SCG bearer, and/or the split bearer. The RLC entity, at the receiver 204, could be an LTE entity, or NR RLC entity. The RLC entity, at the receiver 204, could buffer the out of order RLC SDUs or deliver the moment it receives to higher layer PDCP entity. For example, a receiver LTE RLC entity buffers out of order received RLC PDUs and try to deliver in-order RLC SDUs to higher layer PDCP entity. This buffering at the receiver LTE RLC entity can be overridden if the network configures out-of-order-delivery to higher layer (i.e., PDCP entity). A receiver NR RLC entity delivers the received RLC PDUs to higher layer PDCP entity as soon as they are received as defined in the 3GPP standard.

If the receiver 204 does not receive the one or more out of order RLC PDUs from the transmitter 202 after the expiry of the RLC packet recovery timer, the receiver 204 at the RLC entity may send an RLC status report to the transmitter 202. The RLC status report may indicate an RLC acknowledgement (ACK) for the one or more out of order RLC PDUs. The receiver 204 may send the RLC ACK to the transmitter 202 (e.g., indicate discontinuation of interest in receiving the one or more out of order RLC PDUs from the transmitter 202) since at that time the PDCP entity may move ahead by updating its PDCP state variables. In embodiments, the receiver 204 may send the RLC ACK to the transmitter 202 only if channel conditions (e.g., in an example, Block Error Rate (BLER) being less than 25%) are good (e.g., sufficient0 and irrespective of an RLC status prohibit timer running status (as defined in the 3GPP specification). In an example, a bad signal conditions can be defined as RSRP<−105, SINR<=0, and good signal conditions can be defined as RSRP>−95, SINR>=1. On sending the RLC ACK to the transmitter 202, the receiver 204 may enable the transmission of the plurality of RLC SDUs corresponding to the received plurality of PDUs (e.g., without the one or more out of order PDUs) from the RLC entity to the PDCP entity. The order of the RLC ACK transmission to the transmitter 202 and enabling the transmission of the plurality of RLC SDUs corresponding to the received plurality of PDUs by the receiver 204 RLC entity is an implementation choice. The missed RLC PDUs or PDCP PDUs may not be recovered if the higher layer application is an UDP. However, for TCP application, the missed RLC PDUs or PDCP PDUs are the missed TCP/IP PDUs which will be recovered via the TCP Retransmission or fast TCP retransmission method.

The receiver 204 may enable the PDCP entity to accept the plurality of RLC SDUs received from the RLC entity as the plurality of PDCP PDUs, since the PDCP reordering timer has not expired. The PDCP entity may forwards the received PDCP PDUs to the higher layer. Thus, recovering the out of order PDUs, at the RLC entity, may prevent or reduce wastage of network resources and/or reduce power consumption of the receiver 204.

In embodiments, for managing the order of the PDUs for processing, the receiver 204 at the RLC entity may receive the plurality of RLC PDUs from the transmitter 202 over at least one of, the MCG bearer, the SCG bearer, and/or the split bearer. The receiver 204 may enable the RLC entity to forward the received plurality of RLC PDUs as the PDCP PDUs to the PDCP entity. The receiver 204 may initiate the PDCP reordering timer at the PDCP entity on detecting the one or more out of order PDCP PDUs in the received plurality of PDCP PDUs from the RLC entity. On initiating the PDCP reordering timer, the receiver 204 at the RLC entity may detect the one or more out of order RLC PDUs in the received plurality of RLC PDUs. The receiver 204, at the RLC entity, may initiate an RLC reassemble timer/RLC reorder timer (RLC_Reassembly Timer) to recover the RLC PDUs. In embodiments, the RLC_Reassembly timer may be implemented as defined in the 3GPP standard.

In an example, the RLC entity at the receiver 204 has received up to PDU SNs 9 and the RLC entity is waiting to receive PDU SN 10. At this moment T, no RLC reassemble timer is running. At time T+1, the RLC entity at the receiver 204 receives PDU SN 15, so it is first out of order RLC PDU received and receiver RLC will start the RLC re-assembly timer to recover PDU SN 10 to 14. If within expiry of the RLC assembly timer all PDUs with SN less than 15 is not received; the smallest missing RLC PDU SN is the first out of order RLC PDU. So, in the example, if no RLC PDUs received between SN 10 to 14, the first missed out PDU is 10; OR if few RLC PDUS received say 10, 12, 13 . . . then first missed out RLC PDU is 11.

On detecting the out of order RLC PDUs even after the expiry of the RLC assemble timer, the receiver 204 at the RLC entity may attempt to recover the one or more out of order RLC PDUs. For recovering the one or more out of order RLC PDUs, the receiver 204 at the RLC entity may prepare a number of RLC status reports within the expiry of the PDCP reordering time. According to embodiments, the RLC status reports may indicate that the one or more out of order RLC PDUs have not been received and/or request retransmission of the one or more out of order RLC PDUs. The receiver 204 may prepare the number of RLC status reports such that the number of RLC status reports is greater than or equal to ‘1’ and lesser than or equal to an integer factor of the PDCP reordering timer divided by the RLC reassemble timer. The receiver 204, at the RLC entity, may send the prepared number of RLC status reports to the transmitter 202 before the expiry of the PDCP reordering time to recover the one or more out of order RLC PDUs. The receiver 204, at the RLC entity, may send the number of RLC status reports to the transmitter 202 irrespective of the status prohibit timer running status.

If the receiver 204 receives the one or more out of order RLC PDUs from the transmitter 202 in response to the sent number of RLC status reports (e.g., before the expiry of the PDCP reordering time), the receiver 204 may enable the transmission of the plurality of RLC SDUs from the RLC entity to the PDCP entity. The plurality of RLC SDUs may correspond to the plurality of RLC PDUs including the received out of order RLC PDUs (e.g., the RLC PDUs in the ordered sequence).

If the receiver 204 does not receive the one or more out of order RLC PDUs from the transmitter 202 in response to the sent number of RLC status report (e.g., before the expiry of the RLC packet recovery timer), the receiver 204 at the RLC entity may sends the RLC ACK to the transmitter 202 (e.g., indicating discontinuation of interest in reception of the one or more out of order RLC PDUs). In response to receiving the RLC ACK from the receiver 204, the transmitter 202 may not send the one or more out of order RLC PDUs to the receiver 204, as the transmitter 202 considers that (e.g., may response as though) the receiver 204 has received all the PDUs based on the received RLC ACK. On sending the RLC ACK to the transmitter 202, the receiver 204 may enable the transmission of the plurality of RLC SDUs corresponding to the received plurality of PDUs (e.g., without the one or more out of order PDUs) from the RLC entity to the PDCP entity.

The receiver 204 may enable the PDCP entity to accept the plurality of RLC SDUs received from the RLC entity as the plurality of PDCP PDUs, since the PDCP reordering timer has not expired. The PDCP entity may forward the received PDCP PDUs to the higher layer. Thus, recovering the out of order PDUs, at the RLC entity, may prevent or reduce wastage of network resources and/or reduce power consumption of the receiver 204.

In embodiments, the receiver 204 may be configured to recover the one or more out of order PDCP PDUs detected at the PDCP entity if the receiver 204 is the MUSIM UE. The receiver 204 may recover the one or more out of order PDCP PDUs based on a Radio Frequency (RF) tune-away time and the PDCP reordering timer. The RF tune-away time may be a duration in which the receiver 204 may be tuned to another transmitter of a different RAT (e.g., a different SIM, stack, etc.).

If the RF tune-away time is known and relatively smaller than the PDCP reordering time, the receiver 204 at the PDCP entity may be configured to:—
terminate the PDCP reordering timer initiated at the PDCP entity and store remaining values (e.g., remaining time period) of the PDCP reordering time (e.g., the PDCP reorder timer may be stopped/paused at a current value and this current value may be stored in a memory), in response to (e.g., at) an event of RF tune away (e.g., the receiver 204 has been tuned to different RAT); and
restart the PDCP reordering timer with the stored remaining values of the PDCP reordering time (e.g., resume the PDCP reorder timer at the current value), once the receiver 204 tunes back to the transmitter 202 (e.g., in response to, and/or at, an event of RF tune-in).

If the RF tune-away time is known and larger than the PDCP reordering time, the receiver 204 may be configured to enable the RLC entity to send the plurality of RLC SDUs corresponding to the received plurality of RLC PDUs to the higher layer irrespective of the expiry of the PDCP reordering time, at the event of RF tune-in.

If the RF tune-away time is unknown, the receiver 204 may be configured to:
restart the PDCP reordering timer with the stored remaining values, at the event of RF tune-in; or
enable the RLC entity to send the plurality of RLC SDUs corresponding to the received plurality of RLC PDUs to the higher layer irrespective of the expiry of the PDCP reordering time, at the event of RF tune-in.

In embodiments, the receiver 204 may be configured to enable the PDCP entity to deliver old PDCP PDUs received after the expiry of the PDCP reordering timer to the respective higher layer, if a difference between the PDCP state variables (PDCP RX_DELIV) and a count of the old PDCP PDUs satisfies (for example: lesser than or equal to) a SN threshold.

In embodiments, the receiver 204 may be configured to terminate a process of initiating the PDCP reordering timer, on detecting a reception of the one or more out of order PDCP PDUs received at the PDCP entity and a reception of the plurality of RLC PDUs in the correct sequence at the respective RLC entity.

FIG. 2 shows example units/elements of the wireless communication system 200, but it is to be understood that embodiments are not limited thereon. In embodiments, the wireless communication system 200 may include less or a greater number of elements. Further, the labels or names of the units are used only for illustrative purposes and do not limit the scope of embodiments herein. One or more units may be combined together to perform the same or a substantially similar function in the wireless communication system 200.

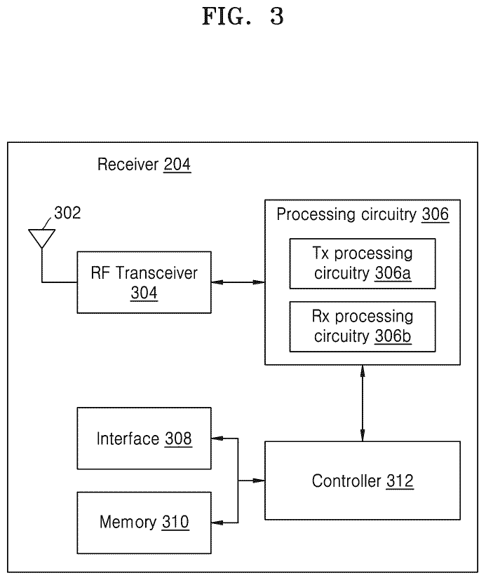

FIG. 3 is a block diagram depicting various components of the receiver 204 (the BS, the UE, or the like) for recovering the out of order PDUs, according to embodiments as disclosed herein. The receiver 204 may include at least one antenna 302, at least one RF transceiver 304, processing circuitry 306, an interface 308, a memory 310, and/or a controller 312. The processing circuitry 306 may include transmission (Tx) processing circuitry 306a, and/or reception (Rx) processing circuitry 306b.

The antenna 302 may be configured to receive RF signals from the transmitter 202 over the communication channel 206. The antenna 302 may provide the received RF signals to the RF transceiver 304.

The RF transceiver 304 may be configured to generate Intermediate Frequency (IF) signals/baseband signals by down converting the received RF signals. The RF transceiver 304 may provide the generated IF signals to the Rx processing circuitry 306b.

The Rx processing circuitry 306b may be configured to perform at least one processing action (e.g., filtering, decoding, digitizing the IF signals (conversion of analog to digital form), and so on) on the IF signals. The RX processing circuitry 306b may provide the processed IF signals to the controller 312 for further processing. In an example herein, the processed IF signals may include the PDUs including the control information and the data.

The Tx processing circuitry 306a may be configured to receive analog and/or digital data from the controller 312. The Tx processing circuitry 306a may generate the IF signals by performing at least one of encoding the received data, multiplexing the received data, and so on. The Tx processing circuitry 306a may further provide the generated IF signals to the RF transceiver 304. The RF transceiver 304 may further up-convert the received IF signals to RF signals and transmit the RF signals to at least one external entity (e.g., the transmitter 202, or any other device) via the antenna 302.

The interface 308 may be configured to enable the receiver 204 to communicate with the transmitter 202 over the communication channel 206. Examples of the interface 308 may be at least one of, but is not limited to, a wired or wireless fronthaul interface, a wired or wireless backhaul interface, or any structure supporting communications over a wired or wireless connection.

The memory 310 may store at least one of, the SNs of the PDUs received from the transmitter 202, the PDCP reordering time, the time value set for at least one of, the RLC packet recovery timer, the RLC assemble timer, or the like, the RF tune-away time, and so on. The memory 310 may also store a data traffic manager 400, which may be executed by the controller 312 to recover the out of order PDUs. Examples of the memory 310 may be, but are not limited to, NAND, embedded Multimedia Card (eMMC), Secure Digital (SD) cards, Universal Serial Bus (USB), Serial Advanced Technology Attachment (SATA), solid-state drive (SSD), and so on. Further, the memory 310 may include one or more computer-readable storage media. The memory 310 may include one or more non-volatile storage elements. Examples of such non-volatile storage elements may include magnetic hard discs, optical discs, floppy discs, flash memories, and/or forms of electrically programmable memories (EPROM) or electrically erasable and programmable (EEPROM) memories. In addition, the memory 310 may, in some examples, be considered a non-transitory storage medium. The term “non-transitory” may indicate that the storage medium is not embodied in a carrier wave or a propagated signal. However, the term “non-transitory” should not be interpreted to mean that the memory is non-movable. In certain examples, a non-transitory storage medium may store data that may, over time, change (e.g., in Random Access Memory (RAM) or cache).

The controller 312 may include at least one of, a single processer, a plurality of processors, multiple homogeneous or heterogeneous cores, multiple Central Processing Units (CPUs) of different kinds, microcontrollers, special media, and/or other accelerators. The controller 312 may be configured to manage the data traffic by supporting the user plane protocol (the MAC entity, the RLC entity, and/or the PDCP entity).

The controller 312 may receive, at the RLC entity, the plurality of RLC PDUs through the Rx processing circuitry 306b over at least one of, the MCG bearer, the SCG bearer, and/or the split bearer. The controller 312 may enable the RLC entity to forward the received plurality of RLC PDUs as the PDCP PDUs to the PDCP entity. The controller 312 may initiate the PDCP reordering timer, at the PDCP entity, on detecting the one or more out of order PDCP PDUs in the received plurality of PDCP PDUs from the RLC entity. On initiating the PDCP reordering timer, the controller 312 at the RLC entity may detect the one or more out of order RLC PDUs in the received plurality of RLC PDUs. Alternatively, the receiver 204, at the RLC entity, may initiate the RLC reassemble timer to recover the RLC PDUs on initiating the PDCP reordering timer and detect the one or more out of order RLC PDUs even after the expiry of the RLC reassemble timer.

On detecting the out of order RLC PDUs, the controller 312 may recover the one or more out of order RLC PDUs, at the RLC entity, by performing either a first recovery action or a second recovery action. The controller 312 may perform the second recovery action, when the controller 312 detects the out of order RLC PDUs even after the expiry of the RLC reassemble timer. The controller 312 may or may not receive the one or more out of order RLC PDUs from the transmitter 202, on performing the first or second recovery actions. The advantage of reporting RLC status report via the first recovery action is to inform the transmitter to place the certain RLC PDUs into the RLC retransmission buffer and thus having priority over new transmission. The second recovery action is to further strengthen the same behaviour. Hence, few still missed out PDUs despite network retransmitting them (on receiving the RLC status report due to first recovery action), can be recovered fast by second recovery action to ensure faster retransmission.

In embodiments, the first recovery action may include initiating the RLC packet recovery timer for recovering the one or more out of order RLC PDUs, and sending the RLC status report to the transmitter, if the one or more out of order RLC PDUs have not been received after the expiry of the RLC packet recovery timer. The controller 312 may set the value (e.g., the full time period, the initial value and/or the final value) of the RLC packet recovery timer as the difference between the PDCP reordering time and the delta value.

In embodiments, the second recovery action may include sending the number of RLC status reports to the transmitter before the expiry of the PDCP reordering timer for recovering the out of order RLC PDUs, and sending the RLC ACK to the transmitter 202, if the controller 312 does not receive the one or more out of order RLC PDUs in response to the sent number of RLC status reports.

On performing the recovery action, the controller 312 may enable the RLC entity to transmit the plurality of RLC SDUs to the PDCP entity. The plurality of RLC SDUs may correspond to the plurality of RLC PDUs in the correct sequence, if the controller 312, at the RLC entity, receives the one or more out of order RLC PDUs from the transmitter 202 after performing the recovery action. Alternatively, the plurality of RLC SDUs may correspond to the received plurality of RLC PDUs without including the missing RLC PDUs, if the controller 312, at the RLC entity, does not receive the one or more out of order RLC PDUs from the transmitter 202 after performing the first or second recovery actions. According to embodiments, the controller 312 may cause the PDCP entity to further process the RLC SDUs before forwarding the processed data to a higher layer. The processed data may be used by the controller 312 in executing an application to, e.g., receive/store the processed data, generate and/or transmit a response to the processed data, output the processed data to a display and/or another device, etc. According to embodiments, after performing the second recovery action, the controller 312 may generate and send a request to the transmitter 202 to reattempt transmission of the plurality of RLC PDUs and/or the one or more out of order RLC PDUs.

In embodiments, the controller 312 may be configured to detect, at the PDCP entity, the one or more out of order PDCP PDUs in the received plurality of PDCP PDUs/RLC SDUs from the RLC entity and recover the one or more out of order PDCP PDUs. The controller 312 may recover the one or more out of order PDCP PDUs detected at the PDCP entity, based on the RF tune-away time and the PDCP reordering time, if the receiver 204 is the MUSIM (e.g., the UE that supports the multiple SIMs).

If the RF tune-away time is known and is smaller than the PDCP reordering time, the controller 312 may perform a first action and a second action, at the PDCP entity, to recover the one or more out of order PDCP PDUs. The first action may include terminating the PDCP reordering timer initiated at the PDCP entity and storing the remaining values (e.g., a remaining time value) of the PDCP reordering time, at the event of RF tune away. The second action may include restarting the PDCP reordering timer with the stored remaining values of the PDCP reordering time, at the event of RF tune-in.

If the RF tune-away time is known and is larger than the PDCP reordering time, the controller 312 may perform a third action to recover the one or more out of order PDCP PDUs. The third action may include enabling the RLC entity to send the received plurality of RLC PDUs to the PDCP entity irrespective of the expiry of the PDCP reordering time up to a certain threshold time, at the event of RF tune-in.

If the RF tune-away time is unknown, the controller 312 may perform a fourth action or a fifth action to recover the one or more out of order PDCP PDUs. The fourth action may include restarting the PDCP reordering timer with the stored remaining values, at the event of RF tune-in. The fifth action may include enabling the RLC entity to send the plurality of RLC SDUs corresponding to the received plurality of RLC PDUs to the PDCP entity irrespective of the expiry of the PDCP reordering time, at the event of RF tune-in.

It is understood that the controller 312 may perform a permutation combination of the first, second, third, fourth, and/or fifth actions to recover the one or more out of order PDCP PDUs, at the PDCP entity, if the receiver 204 is the MUSIM UE.

In embodiments, the controller 312 may be configured to enable the PDCP entity to deliver the old PDCP PDUs received after the expiry of the PDCP reordering timer to the respective higher layer, if the difference between the current PDCP state variables and the count of the old PDCP PDUs is less than or equal to the SN threshold (e.g., RX_DELIV−OLD PDCP PDU COUNT<=SN threshold).

In an example, if a channel condition of the network is good, receiving the missed-out packets would be very fast. Hence, the proposed method discloses of increasing the PDCP reordering timer by small margin for MUSIM devices. Because, otherwise as per the 3GPP standard, old PDU (i.e., PDU_SN<RX_DELIV, where RX_DELIV updated as part of PDCP reorder timer expiry) should be discarded. So, in conventional methods, network resources would get wasted by receiver RLC entity enforcing RLC retransmission of old PDUs despite higher layer PDCP has moved ahead. The recovery via the RLC retransmission is beneficial only so long the higher layer is interested to receive them. Second, if higher layer application is TCP based, TCP FAST retransmission of the missed out PDUs at higher layer would anyway happen. These will be considered as new PDUS by transmitter PDCP entity and therefore their transmission will be further delayed due to lower layer RLC stuck in older PDUs retransmission rather than new PDUs. So, conventional methods are adding latency; which is being resolved by the proposed methods. Third, higher layer application could be UDP or time sensitive QOS application, video/audio streaming application or call, hence, the proposed method avoids the resource wastage.

Consider an example to understand this: (For the sake of convenience, one to one mapping is assumed between sequence number of PDUs received at RLC, PDCP and TCP layer.) The network configured RLC AM bearer on the UE side for data transmission and reception with PDCP reordering timer as X msec. From, the network RLC SN 1 is received which is forwarded to PDCP and from there to TCP. After this, RLC SN 3 is received from the network which is forwarded to PDCP. Since, SN 2 is not received, the PDCP starts reordering timer. On expiry of reordering timer, PDCP will forward the PDU associated with SN 3 to TCP, set RX_DELIV to 4 and slide the PDCP receive window forward. Since RLC layer is configured in AM mode, UE updates ACK NAK status of recieved RLC PDUs to network through RLC status report. Later on receiving PDU SN 2, RLC forwards the PDU associated with SN 2 to PDCP. But with coventional 3gpp behaviour, since SN 2 is less than RX_DELIV, it is discarded. TCP layer, receives SN 3 without receiving SN 2. It waits for receiving SN 2 from network but since its discarded at PDCP already there is no way to recover the missing SN from PDCP or RLC. Eventually, TCP sends status report sending NACK for SN 2 requesting network side TCP level for re-transmission which in turn negatively affects the throughput behaviour. Here PDCP, instead of discarding, forwards the received SN 2 to TCP, which in turn avoids TCP level re-transmission which avoids the negative impact on DL throughput.

In embodiments, the controller 212 may be configured to terminate the process of initiating the PDCP reordering timer, at the PDCP entity, on detecting the reception of the one or more out of order PDCP PDUs received at the PDCP entity and reception of the plurality of RLC PDUs in the correct sequence at the respective RLC entity.

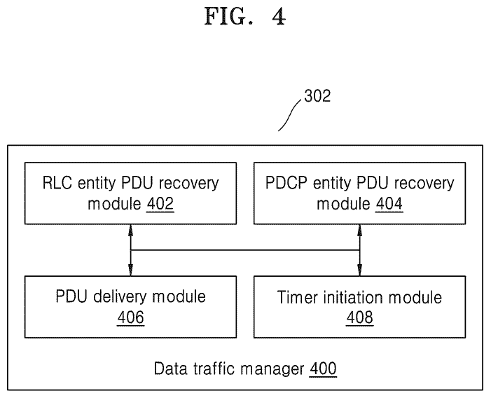

FIG. 4 depicts the data traffic manager 400 in the receiver 204 for recovering the out of order PDUs, according to embodiments as disclosed herein.

The controller 312 may process the data manager 400 (also referred to herein as the data traffic manager 400) to recover the out of order PDUs, at the different entities/layers. The data manager 400 may include a RLC entity PDU recovery module 402, a PDCP entity PDU recovery module 404, a PDU delivery module 406, and/or a timer initiation module 408.

The RLC entity PDU recovery module 402, at the RLC entity, may receive the plurality of RLC PDUs from the transmitter 202 over at least one of, the MCG bearer, the SCG bearer, and/or the split bearer. The RLC entity PDU recovery module 402 may enable the RLC entity to forward the received plurality of RLC PDUs as the PDCP PDUs to the PDCP entity. The RLC entity PDU recovery module 402 may initiate the PDCP reordering timer, at the PDCP entity, on detecting the one or more out of order PDCP PDUs in the received plurality of PDCP PDUs from the RLC entity. On initiating the PDCP reordering timer, the RLC entity PDU recovery module 402, at the RLC entity, may detect the one or more out of order RLC PDUs in the received plurality of RLC PDUs. In such a scenario, the RLC entity PDU recovery module 402 may perform the first recovery action. Alternatively, the RLC entity PDU recovery module 402, at the RLC entity, may initiate the RLC reassemble timer to recover the RLC PDUs on initiating the PDCP reordering timer and detect the one or more out of order RLC PDUs even after the expiry of the RLC reassemble timer. In such a scenario, the RLC entity PDU recovery module 402 may perform the second recovery action.

For performing the first recovery action, the RLC entity PDU recovery module 402, at the RLC entity, may initiate the RLC packet recovery timer, while waiting to recover the one or more RLC PDUs from the transmitter 202. The RLC entity PDU recovery module 402 may set the value of the RLC packet recovery time as the difference between the PDCP reordering time and the delta value. The delta value may be at least one transmission time interval (TTI) used for delivering the RLC status by the receiver 204 to the transmitter 202.

For performing the second recovery action, the RLC entity PDU recovery module 402 may prepare the number of RLC status reports within the expiry of the PDCP reordering time. The prepared number of RLC status reports may be greater than or equal to ‘1’ and lesser than or equal to the integer factor of the PDCP reordering timer (e.g., a full time period, initial value and/or final value of the PDCP reordering timer) divided by the RLC reassemble timer (e.g., a full time period, initial value and/or final value of the RLC reassemble timer). The RLC entity PDU recovery module 402, at the RLC entity, may send the prepared number of RLC status reports to the transmitter 202, before the expiry of the PDCP reordering time to recover the one or more out of order RLC PDUs. The RLC entity PDU recovery module 402, at the RLC entity, may send the number of RLC status reports to the transmitter 202 irrespective of the status prohibit timer running status.

In an embodiment, the status prohibit timer would delay reporting of ACK NAK status of received RLC PDUs to the transmitter where the required goal is to let the transmitter know as early as possible with the upper bound of PDCP reordering timer window. So, the intention of recovering the missed out RLC PDUs could be delayed if the status prohibit timer is higher. In above example, consider status prohibit timer is 80 msec and PDCP reordering timer is 100 msec. Then, RLC sends status report for SN 2 at 80th msec and the UE is left with a smaller window to recover it.

On performing the first recovery action, the RLC entity PDU recovery module 402 may check if the one or more RLC PDUs have been received before the expiry of the RLC packet recovery time. Alternatively, on performing the second recovery action, the RLC entity PDU recovery module 402 may checks if the one or more RLC PDUs have been received in response to the number of RLC status reports sent to the transmitter 202 before the expiry of the PDCP reordering timer.

If the one or more out of order RLC PDUs have been received after performing the first or second recovery actions, the RLC entity PDU recovery module 402 may terminates the RLC Packet recovery timer (if its operating in case of the first recovery action) and enable the RLC entity to transmit the plurality of RLC SDUs to the PDCP entity. The plurality of RLC SDUs may correspond to the plurality of RLC PDUs including the received out of order RLC PDUs (e.g., the RLC PDUs in the correct sequence).

If the one or more out of order RLC PDUs have been received after performing the first or second recovery actions, the RLC entity PDU recovery module 402 at the RLC entity may send the RLC ACK to the transmitter 202 for the one or more out of order RLC PDUs. On sending the RLC ACK to the transmitter 202, the first RLC entity PDU recovery module 402 may enable the RLC entity to transmit the plurality of RLC SDUs corresponding to the received plurality of PDUs (e.g., without the one or more out of order PDUs) to the PDCP entity.

The PDCP entity PDU recovery module 404 may be configured to detect and recover the out of order PDCP PDUs, at the PDCP entity, based on the RF tune-away time and the PDCP reordering time if the receiver 204 is the MUSIM UE.

If the RF tune-away time is known and smaller than the PDCP reordering time, the PDCP entity PDU recovery module 404 may terminate the PDCP reordering timer initiated at the PDCP entity and store remaining values of the PDCP reordering time at the event of RF tune away, and restart the PDCP reordering timer with the stored remaining values of the PDCP reordering time, at the event of RF return.

If the RF tune-away time is known and larger than the PDCP reordering time, the PDCP entity PDU recovery module 404 may enable the RLC entity to send the plurality of RLC SDUs from the RLC entity to the PDCP entity irrespective of the expiry of the PDCP reordering time, at the event of RF tune-in.

If the RF tune-away time is unknown, the PDCP entity PDU recovery module 404 may restart the PDCP reordering timer with the stored remaining values, at the event of RF tune-in; or enable the RLC entity to send the plurality of RLC SDUs o the PDCP entity irrespective of the expiry of the PDCP reordering time, at the event of RF tune-in.

The PDU delivery module 406 may be configured to enable the PDCP entity to deliver the old PDCP PDUs received after the expiry of the PDCP reordering timer to the respective higher layer for certain time SN threshold, which is equal to or greater than the difference between the PDCP state variables and the count of the old PDCP PDUs.

The timer initiation module 408 may be configured to terminate the process of initiating the PDCP reordering timer, on detecting the reception of the one or more out of order PDCP PDUs received at the PDCP entity and reception of the plurality of RLC PDUs in the correct sequence at the respective RLC entity.

The timer initiation module 408 may also be configured to set and vary the PDCP reordering time for the PDCP reordering timer based on the factors such as, but are not limited to, signal conditions, TCP RETX timer value, and so on.

FIGS. 3 and 4 show example units of the receiver 204, but it is to be understood that embodiments are not limited thereon. In embodiments, the receiver 204 may include less or a greater number of elements/units. Further, the labels or names of the units are used only for illustrative purposes and do not limit the scope of embodiments herein. One or more units may be combined together to perform the same or a substantially similar function in the receiver 204.

Embodiments herein further explain managing the data traffic by considering that the receiver 204 is a UE supporting a New Radio (NR) 5G RAT (referred to herein as a UE 204), as an example, but it may be obvious to a person skilled in the art that another device may be considered as the receiver 204. As the UE 204 supports the NR RAT, the UE 204 may use the NR user protocol such as the MAC/NR MAC entity, the RLC/NR RLC entity, and/or the PDCP/NR PDCP entity for processing the received PDUs.

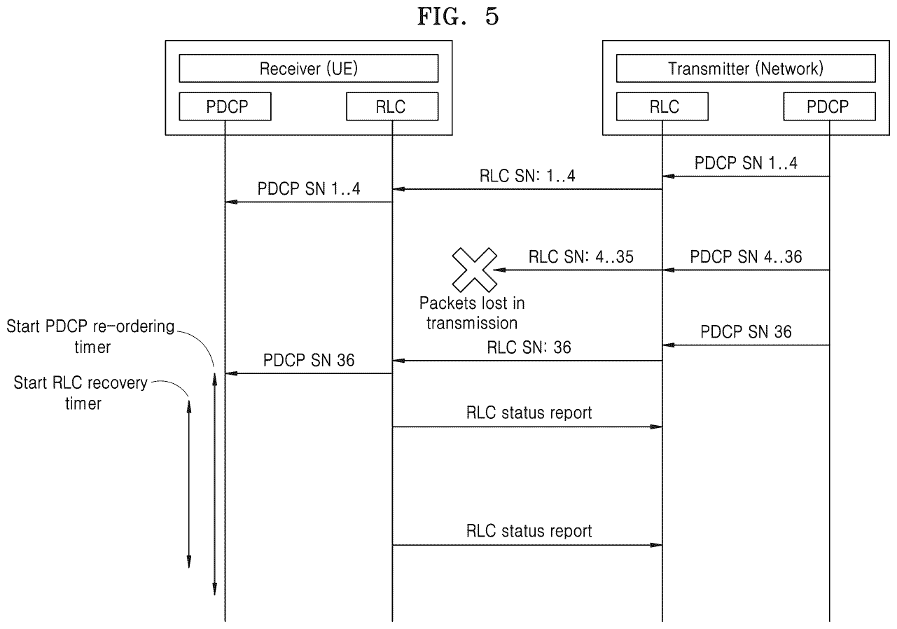

FIG. 5 depicts an example scenario for recovery of the out of order RLC PDUs, at the RLC entity, according to embodiments as disclosed herein.

Consider an example scenario, as depicted in FIG. 5, wherein the UE 204 receives, at the NR PDCP entity, the PDCP PDUs having SNs of 1 2 3 4 36 37 38 and the UE 204 receives, at the NR RLC entity, the RLC PDUs having SNs of 1 2 3 4 36 37 38. The UE 204, at the NR PDCP entity, may initiate the PDCP reordering timer at reception of out of order PDU SN 36. In such a scenario, the UE 204, at the RLC entity, may initiate the RLC packet recovery timer at the reception of the out of order PDU SN 36. The UE 204 may set the values of the RLC packet recovery timer as the difference between the PDCP reordering timer (e.g., the full time period of the PDCP reordering timer) and the delta; e.g., the at least one TTI (transmission time interval) used to ensure (or improve the likelihood that) the delivery of the RLC status report to the transmitter 202. This is to ensure (or improve the likelihood) that RLC retransmission of missed PDUs are received before the PDCP reordering timer expiry. In an example herein, the RLC packet recovery timer may allow at least 3 to 4 slots for the UE 204 to send the RLC status report to the transmitter 202, at the RLC entity.

Consider that the UE 204, at the RLC entity, may not receive the missing RLC PDUs between 5 and 35 by the expiry of the RLC packet recovery timer. In such a scenario, the UE 204 may send the RLC status reports for the missing RLC PDUs between 5 and 35 to the transmitter 202. The RLC status reports may include the RLC ACK, which acknowledges the missed RLC PDUs.

Further, the PDCP reordering timer may expire, when the UE 204, at the NR RLC entity, does not receive PDUs 5 6 7 8 . . . till 35, as the transmitter 202 has been discarded (e.g., has not resent and/or is no longer monitoring the status of) the missed PDUs between 5 and 35 in response to the RLC ACK received from the UE 204. On the expiry of the PDCP reordering timer, the UE 204, at the NR PDCP entity and the RLC entity, may update the PDCP state variables and the RLC state variables respectively to 39 to receive the PDUs from the SN 39.

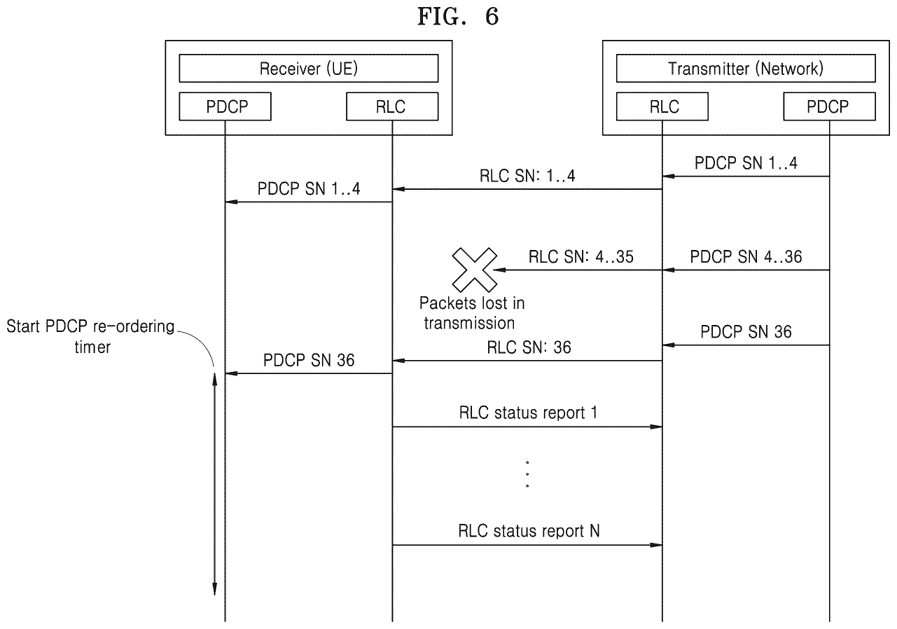

FIG. 6 depicts another example scenario for recovery of the out of order RLC PDUs, at the RLC entity, according to embodiments as disclosed herein.

Consider an example scenario, as depicted in FIG. 6, wherein the UE 204 receives, at the NR PDCP entity, the PDCP PDUs having SNs of 1 2 3 4 36 37 38 and the UE 204 receives, at the NR RLC entity, the RLC PDUs having SNs of 1 2 3 4 36 37 38. The UE 204, at the NR PDCP entity, may initiate the PDCP reordering timer at the reception of out of order PDU SN 36, and the UE 204, at the NR RLC entity, may initiate the RLC reassemble timer at the reception of out of order PDU SN 36. In such a scenario, the UE 204, at the NR RLC entity, may prepare the number of RLC status reports about RLC receive status, before the expiry of the PDCP reordering timer. The number of RLC status reports, N, may be 1<=N<, F, wherein F is the integer factor of (PDCP_Reorder_Timer/RLC_Reassembly Timer) excluding RLC status prohibit timer (e.g., with regards to the values of the respective timers).

The UE 204, at the NR RLC entity, may acknowledge the missed RLC PDUs between 5 and 35 at (F+1)^{th} report in good signal to avoid retransmission. Further, the UE 204, at the NR RLC entity, may not receive the RLC PDUs 5 6 7 8 till 38 after the expiry of the PDCP reordering timer, as the transmitter 202 has been discarded (e.g., has not resent and/or is no longer monitoring the status of) the missed PDUs between 5 and 35 in response to the RLC ACK received from the UE 204. On the expiry of the PDCP reordering timer, the UE 204, at the NR PDCP entity and the RLC entity, may update the PDCP state variables and the RLC state variables respectively to 39 to receive the PDUs from the SN 39.

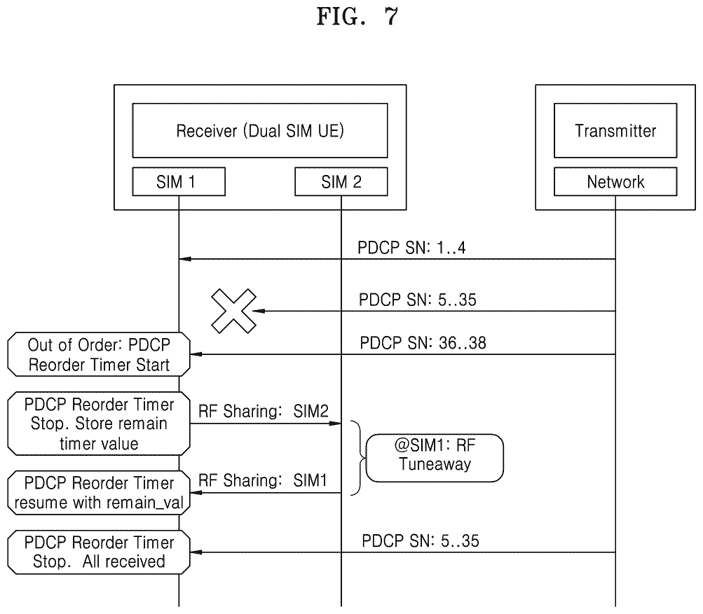

FIG. 7 depicts an example scenario for recovery of the out of order RLC PDUs, at the PDCP entity, according to embodiments as disclosed herein.

Consider an example scenario, wherein the UE 204, at the NR PDCP entity receives the PDU SNs of 1 2 3 4 36 37 38 and the UE 204, at the NR RLC entity, receives the PDU SNs of 12 3 4 36 37 38. The UE 204 may initiate the PDCP reordering timer at the PDCP entity, on the reception of the out of order SN 36. Further, consider that the event of the RF tune away occurs (e.g., blackout situation), wherein the UE 204 may be tuned to another RAT. In such a scenario, the UE 204, at the PDCP entity, may terminate the PDCP reordering timer and store the remaining values (e.g., the remaining time period) of the PDCP reordering timer. Thus, the expiry of the PDCP reordering timer may no longer be observed during the RF tune away time (e.g., blackout duration). The UE 204, at the PDCP entity, may restart the PDCP reordering timer with the stored remaining values (e.g., to have the remaining time period stored), when the UE 204 returns to the same RAT or a similar RAT (e.g., the event of RF tune-in). In an example herein, consider that the UE 204, at the RLC entity, receives the RLC PDUs, on restarting the PDCP reordering time after the event of RF tune-in. In such a scenario, the UE 204 may enable the NR RLC entity to send the received RLC PDUs to the NR PDCP entity. All the PDUs may be accepted at the PDCP entity, as the PDCP state variable has not been updated since the PDCP reordering time has not expired at the PDCP entity.

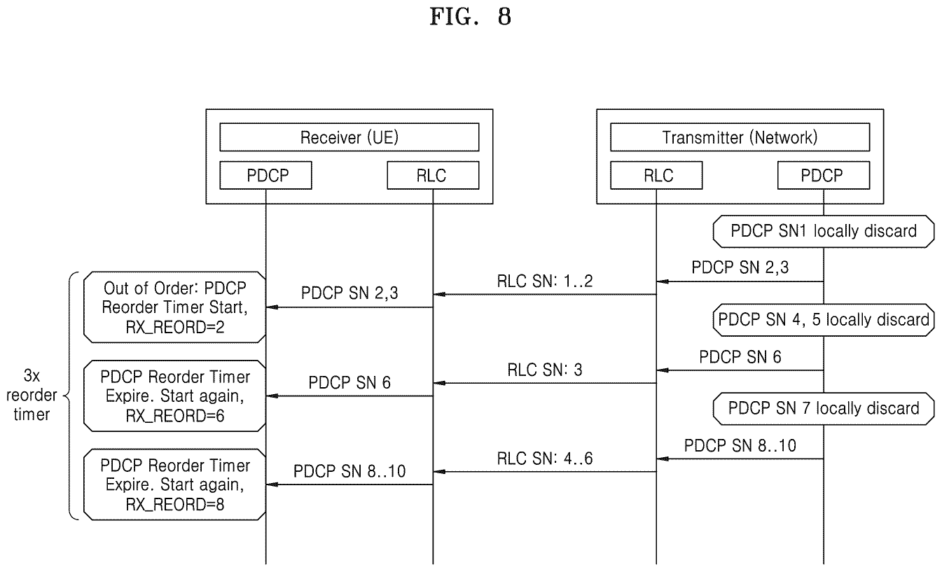

FIG. 8 is an example diagram depicting an example scenario of initiating the PDCP reordering time, at the PDCP entity, according to embodiments as disclosed herein.

Consider an example scenario, wherein the UE 204, at the NR PDCP entity and at the NR RLC entity, receives the PDUs with PDCP SNs of 2 3 6 8 9 10 over RLC SNs 1 2 3 4 5 6, respectively. That is, PDCP SN 2 was received on RLC PDU SN 1 and PDCP SN 10 was received on RLC PDU SN 6. This example scenario covers—certain PDCP SNs being dropped locally at transmitter for reason unknown. Generally, in Voice over New Radio (VoNR) calls, in poor signal conditions, these may be observed. In such a scenario, the UE 204 may not initiate the PDCP reordering timer at all out of order PDCP SN receptions, as the PDUs are in the correct sequence at the NR RLC entity. The UE 204 may attempt to start a PDCP reordering timer event three times (e.g., to initiate the PDCP reordering timer at the SNs 2, 6 and 8, respectively). However, all three of the PDCP reordering time events may not start, as the PDU SNs are continuous at the NR RLC entity. The NR PDCP entity may receive the SN 6 and the SN 8 using the SN 3 and the SN 4 at the NR RLC entity, respectively. Thus, resulting in no (or lower) delay while delivering the data to the application, as the three preordering timer events do not start at the PDCP entity.

In above example, the RLC level all PDUs are received in sequence. There is no SN miss at RLC level it is confirmed that PDCP SN 1 is locally discarded at transmitter side. So, this PDU will not be received even after waiting till reordering timer expiry ends. So, instead of waiting for this PDU, the PDCP will forward the PDU to higher layers thus reducing the delay of reordering timer. The RLC SN 1 contains PDCP PDU mapping to PDCP SN 2. In conventional method or 3gpp based method, the PDCP side, reordering timer is started for missing PDCP SN 1. This results an additional delay in forwarding the packet to higher layers.

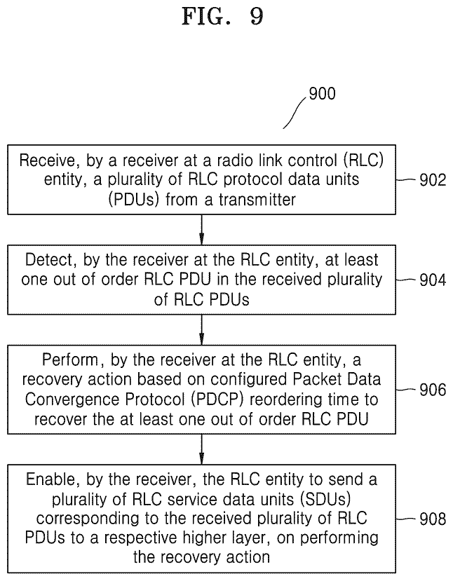

FIG. 9 is a flow diagram 900 depicting a method for managing the data traffic in the wireless communication system 200, according to embodiments as disclosed herein.

At operation 902, the method may include receiving, by the receiver 204 at the RLC entity, the plurality of the RLC PDUs from the transmitter 202. At operation 904, the method may include detecting, by the receiver 204 at the RLC entity, the at least one out of order RLC PDU in the received plurality of RLC PDUs.

At operation 906, the method may include performing, by the receiver 204 at the RLC entity, the recovery action based on the PDCP reordering time to recover the at least one out of order RLC PDU. At operation 908, the method may include enabling, by the receiver 204, the RLC entity to send the plurality of RLC SDUs corresponding to the received plurality of RLC PDUs to the respective higher layer, on performing the recovery action. In an example herein, the higher layer may be the PDCP entity. The various operations in method 900 may be performed in the order presented, in a different order or simultaneously (or contemporaneously). Further, in embodiments, one or more operations listed in FIG. 9 may be omitted.

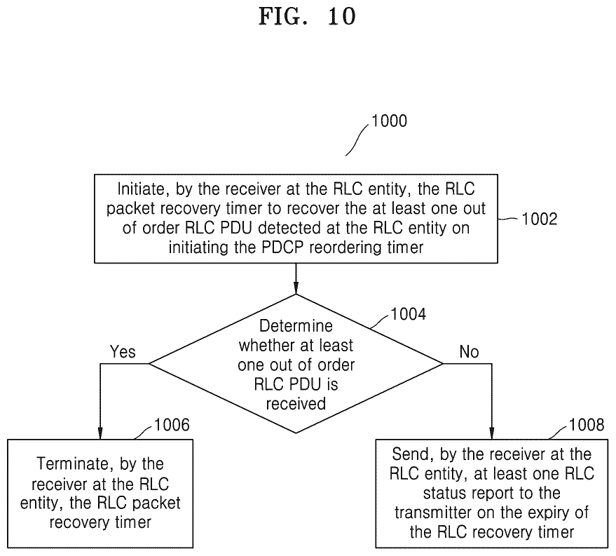

FIG. 10 is a flow diagram 1000 depicting a method for performing the first recovery action to recover the at least one out of order RLC PDU at the RLC entity, according to embodiments as disclosed herein.

At operation 1002, the method may include initiating, by the receiver 204 at the RLC entity, the RLC packet recovery timer to recover the at least one out of order RLC PDU detected at the RLC entity on initiating the PDCP reordering timer. The receiver 204 may set the value of the RLC packet recovery timer as the difference between the PDCP reordering time and the delta value. At operation 1004, the method includes determining whether at least one out of order RLC PDU is received.

At operation 1006, the method may include terminating, by the receiver 204 at the RLC entity, the RLC packet recovery timer, upon receiving the at least one out of order RLC PDU.

At operation 1008, the method may include sending, by the receiver 204 at the RLC entity, the at least one RLC status report to the transmitter 202, upon not receiving the at least one out of order RLC PDU by the expiry of the RLC recovery timer. The at least one RLC status report may indicate the RLC ACK for the at least one out of order RLC PDU. The receiver 204 may send the at least one status report to the transmitter 202 only if the channel conditions are good. Here, channel consideration may be considered to ensure (or improve the likelihood) that the UE does not experience a poor signal and radio link recovery via RLF (radio link failure) may be recovered which should not be hampered by transmitting false ACK over RLC status report; given that receiver PDCP has shown no interest in receiving the old PDCP PDUs. The various operations in method 1000 may be performed in the order presented, in a different order or simultaneously (or contemporaneously). Further, in embodiments, one or more operations listed in FIG. 10 may be omitted.

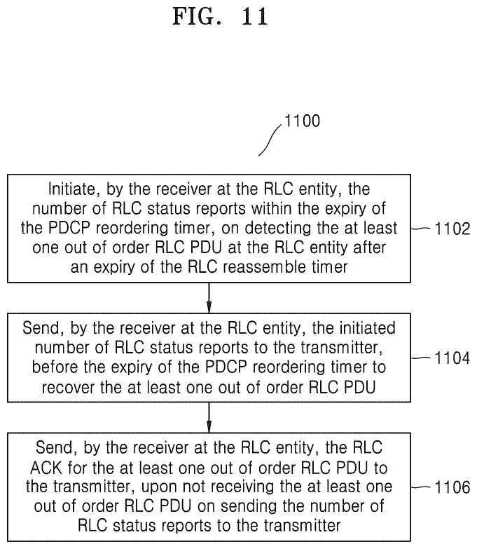

FIG. 11 is a flow diagram 1100 depicting a method for performing the second recovery action to recover the at least one out of order RLC PDU at the RLC entity, according to embodiments as disclosed herein.

At operation 1102, the method may include initiating, by the receiver 204 at the RLC entity, the number of RLC status reports within the expiry of the PDCP reordering timer, on detecting the at least one out of order RLC PDU at the RLC entity after an expiry of the RLC reassemble timer. The number of RLC status reports may be greater than or equal to ‘1’ and lesser than or equal to an integer factor of the PDCP reordering timer divided by the RLC reassemble timer.

At operation 1104, the method may include sending, by the receiver 204 at the RLC entity, the initiated number of RLC status reports to the transmitter 202, before the expiry of the PDCP reordering timer to recover the at least one out of order RLC PDU. The receiver 204 may send the status reports to the transmitter 202 irrespective of the status prohibit timer running status to ensure (or increase the likelihood of) at least one RLC status report to the transmitter 202 RLC.

At operation 1106, the method may include sending, by the receiver 204 at the RLC entity, the RLC ACK for the at least one out of order RLC PDU to the transmitter 202, upon not receiving the at least one out of order RLC PDU on (e.g., after) sending the number of RLC status reports to the transmitter 202. The various operations in method 1100 may be performed in the order presented, in a different order or simultaneously (or contemporaneously). Further, in embodiments, one or more operations listed in FIG. 11 may be omitted.

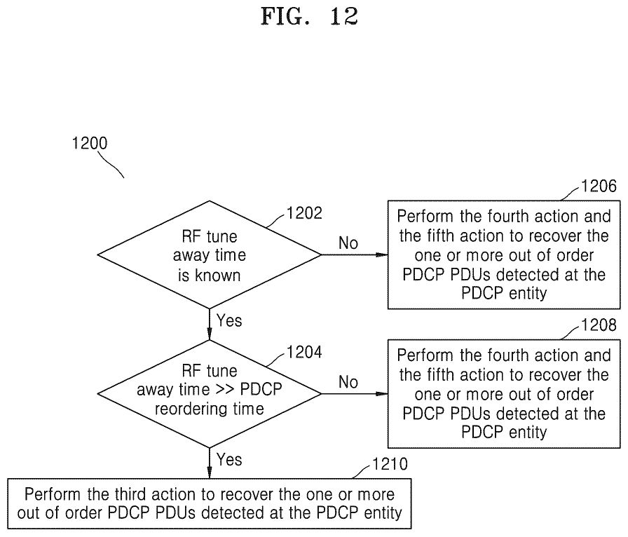

FIG. 12 is a flow diagram 1200 depicting a method for recovering the at least one out of order PDCP PDUs at the PDCP entity, according to embodiments as disclosed herein. Embodiments herein enable the receiver 204 to recover the at least one out of order PDCP PDUs at the PDCP entity based on the RF tune away-time and the PDCP reordering time, if the receiver 204 is the MUSIM UE.

At 1202, the method includes determining whether the RF tune away time is known. If the RF tune away time is known then, at 1204, the method includes determining whether the RF tune away time>>>PDCP reordering time. If the RF tune away time is not known then, at 1206, the method includes performing the fourth action and the fifth action to recover the one or more out of order PDCP PDUs detected at the PDCP entity. The fourth action may include restarting the PDCP reordering timer with the stored remaining values, at the event of RF tune-in. The fifth action may include enabling the RLC entity to send the plurality of RLC SDUs corresponding to the received plurality of RLC PDUs to the PDCP entity irrespective of the expiry of the PDCP reordering time, at the event of RF tune-in.

If the RF tune away time is not the PDCP reordering time then, at 1208, the method includes performing the third action to recover the one or more out of order PDCP PDUs detected at the PDCP entity. If the RF tune away time>>>PDCP reordering time then, at 1210, the method includes performing the first action and the second action to recover the one or more out of order PDCP PDUs detected at the PDCP entity. The first action may include terminating the PDCP reordering timer initiated at the PDCP entity and storing the remaining values of the PDCP reordering time, at the event of RF tune away. The second action may include restarting the PDCP reordering timer with the stored remaining values of the PDCP reordering time, at the event of RF tune-in. It is understood that the receiver 204 may perform a permutation combination of the first, second, third, fourth, and/or fifth actions to recover the one or more out of order PDCP PDUs, at the PDCP entity, if the receiver 204 is the MUSIM UE.

The various operations in method 1200 may be performed in the order presented or with certain permutation combination, in a different order or simultaneously (or contemporaneously). Further, in embodiments, one or more operations listed in FIG. 12 may be omitted.

Embodiments disclosed herein may be implemented through at least one software program running on at least one hardware device and performing network management functions to control the elements. The elements shown in FIGS. 2-4 may be at least one of a hardware device, or a combination of hardware device and software module.

Embodiments disclosed herein describe methods and systems for managing data traffic in a wireless communication system. Therefore, it is understood that the scope of the protection is extended to such a program and in addition to a computer readable means having a message therein, such computer readable storage means contain program code means for implementation of one or more operations of the method, when the program runs on a server or mobile device or any suitable programmable device. The method is implemented in embodiments through or together with a software program written in e.g., Very high speed integrated circuit Hardware Description Language (VHDL) another programming language, or implemented by one or more VHDL or several software modules being executed on at least one hardware device. The hardware device may be any kind of portable device that may be programmed. The device may also include means which could be e.g., hardware means like e.g., an ASIC, or a combination of hardware and software means, e.g., an ASIC and an FPGA, or at least one microprocessor and at least one memory with software modules located therein. Embodiments described herein could be implemented partly in hardware and partly in software. Alternatively, the inventive concepts may be implemented on different hardware devices, e.g., using a plurality of CPUs.

Conventional devices having a receiver with PDCP and RLC layers discard out of order PDUs (e.g., missing PDUs) at the PDCP layer upon expiration of a PDCP reordering timer. The RLC layer continues to request retransmission of the out of order PDUs after the PDCP reordering timer has expired and forwards the out of order PDUs to the PDCP layer upon receipt. The PDCP layer, however, discards the out of order PDUs as old PDUs due to the expiration of the PDCP reordering timer. Accordingly, in circumstances in which the out of order PDUs are not received by the RLC layer prior to expiration of the PDCP reordering timer, the RLC layer may become stuck in a continuous loop of requesting retransmission of and forwarding the out of order PDUs. In such circumstances, the conventional devices consume excessive resources (e.g., power, processor, memory, delay, bandwidth, etc.). These circumstances may occur more frequently in MUSIM devices that may perform RF tune away to a different SIM after the PDCP reordering timer has been started and before the out of order PDUs are received by the RLC layer.

However, according to embodiments, improved devices having a receiver with PDCP and RLC layers is provided. For example, upon the PDCP reordering timer being started the receiver (e.g., the RLC layer) may detect an out of order RLC PDU among RLC PDUs received from a transmitter. In response to detecting the out of order RLC PDU, the receiver (e.g., the RLC layer) may request the transmitter to retransmit of the out of order RLC PDU and/or send an acknowledgement to the transmitter that the out of order RLC PDUs have been received. Accordingly, the receiver attempts to recover the out of order RLC PDU before expiration of the PDCP reordering timer. However, in the event the receiver is unable to recover the out of order RLC PDU before the expiration of the PDCP reordering timer, the receiver indicates to the transmitter that the out of order RLC PDU has been received, thereby avoiding the circumstances in which the RLC layer may become stuck continuously requesting retransmission of and forwarding the out of order PDUs without these out of order PDUs being processed and/or forwarded by the PDCP layer. Also, in embodiments in which the receiver is in a MUSIM device, the receiver may store a value of the PDCP reordering timer at RF tune away for use in resuming the PDCP reordering timer at RF tune-in. Therefore, the improved devices overcome the deficiencies of the conventional devices to at least reduce resource consumption (e.g., power, processor, memory, delay, bandwidth, etc.).

According to embodiments, operations described herein as being performed by the wireless communication system 200, the transmitter 202, the receiver 204, the at least one RF transceiver 304, the processing circuitry 306, the controller 312, the Tx processing circuitry 306a, the Rx processing circuitry 306b, the data manager 400, the RLC entity PDU recovery module 402, the PDCP entity PDU recovery module 404, the PDU delivery module 406, the timer initiation module 408, the RLC entity, the RLC layer, the PDCP entity, the PDCP layer, the MAC entity, the MAC layer, the TCP entity and/or the TCP layer may be performed by processing circuitry. The term ‘processing circuitry,’ as used in the present disclosure, may refer to, for example, hardware including logic circuits; a hardware/software combination such as a processor executing software; or a combination thereof. For example, the processing circuitry more specifically may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc.

The various operations of methods described above may be performed by any suitable device capable of performing the operations, such as the processing circuitry discussed above. For example, as discussed above, the operations of methods described above may be performed by various hardware and/or software implemented in some form of hardware (e.g., processor, ASIC, etc.).

The software may comprise an ordered listing of executable instructions for implementing logical functions, and may be embodied in any “processor-readable medium” for use by or in connection with an instruction execution system, apparatus, or device, such as a single or multiple-core processor or processor-containing system.

The blocks or operations of a method or algorithm and functions described in connection with embodiments disclosed herein may be embodied directly in hardware, in a software module executed by a processor, or in a combination of the two. If implemented in software, the functions may be stored on or transmitted over as one or more instructions or code on a tangible, non-transitory computer-readable medium (e.g., the memory 310, etc.). A software module may reside in Random Access Memory (RAM), flash memory, Read Only Memory (ROM), Electrically Programmable ROM (EPROM), Electrically Erasable Programmable ROM (EEPROM), registers, hard disk, a removable disk, a CD ROM, or any other form of storage medium known in the art.

The foregoing description of embodiments will so fully reveal the general nature of embodiments herein that others may, by applying current knowledge, readily modify and/or adapt embodiments for various applications without departing from the generic concept, and, therefore, such adaptations and modifications should and are intended to be comprehended within the meaning and range of equivalents of embodiments. It is to be understood that the phraseology or terminology employed herein is for the purpose of description and not of limitation. Therefore, while embodiments herein have been described, those skilled in the art will recognize that embodiments herein may be practiced with modification within the spirit and scope of embodiments as described herein.

1. A method for managing data traffic in a wireless communication system, the method comprising:
detecting, by a receiver, at least one out of order radio link control (RLC) protocol data unit (PDU) in a plurality of RLC PDUs received from a transmitter;
performing, by the receiver, a recovery action based on a Packet Data Convergence Protocol (PDCP) reordering time to recover the at least one out of order RLC PDU; and
causing, by the receiver, an RLC layer to send a plurality of RLC service data units (SDUs) to a higher layer after the performing the recovery action, the plurality of RLC SDUs corresponding to the plurality of RLC PDUs.

2. The method of claim 1, wherein the PDCP reordering time is based on:
a configuration by the transmitter based on a time period for sending at least one RLC status report to the transmitter; or
at least one of a signal condition or a Transport Control Protocol (TCP) retransmission (RETX) timer value.

3. The method of claim 1, further comprising:
recovering the at least one out of order RLC PDU via at least one of a Master Cell Group (MCG) bearer, a Secondary Cell Group (SCG) bearer, or a split bearer.

4. The method of claim 3, wherein the recovery action comprises:
initiating a RLC packet recovery timer, a value of the RLC packet recovery timer being set as a difference between the PDCP reordering time and a delta value, the delta value being at least one transmission time interval (TTI) for RLC status report delivery;
terminating the RLC packet recovery timer in response to receiving the at least one out of order RLC PDU; and
sending at least one RLC status report to the transmitter based on the at least one out of order RLC PDU not being received by expiration of the RLC packet recovery timer, the at least one RLC status report indicating an RLC acknowledgement (ACK) for the at least one out of order RLC PDU, and the sending the at least one RLC status report is performed according to channel conditions and irrespective of a status prohibit timer running status.

5. The method of claim 1, further comprising:
setting a PDCP reordering timer to the PDCP reordering time in response to detecting at least one out of order PDCP PDU;
initiating a number of RLC status reports before expiration of a PDCP reordering timer, the number of RLC status reports being greater than or equal to ‘1’ and lesser than or equal to an integer factor of the PDCP reordering timer divided by a RLC reassemble timer;
sending the number of RLC status reports to the transmitter before expiration of the PDCP reordering timer, the number of RLC status reports being sent to the transmitter irrespective of a status prohibit timer running status; and
sending an RLC ACK for the at least one out of order RLC PDU to the transmitter in response to a failure to recover the at least one out of order RLC PDU based on the sending the number of RLC status reports to the transmitter.

6. The method of claim 5, further comprising:
detecting, by the receiver, the at least one out of order RLC PDU in response to successful recovery of the at least one out of order RLC PDU based on the sending the number of RLC status reports to the transmitter.

7. The method of claim 1, wherein
the receiver is included in a multiple-universal subscriber identity module (USIM) UE (MUSIM UE); and
the method further comprises recovering, by the receiver, at least one out of order PDCP PDU based on a Radio Frequency (RF) tune-away time and the PDCP reordering time.

8. The method of claim 7, wherein
the RF tune away time is smaller than the PDCP reordering time;
the method further comprises setting a PDCP reordering timer to the PDCP reordering time in response to detecting at least one out of order PDCP PDU; and
the recovering the at least one out of order PDCP PDU comprises:
terminating the PDCP reordering timer and storing a remaining time value of the PDCP reordering timer based on an RF tune away, and
restarting the PDCP reordering timer with the remaining time value based on an RF tune-in.

9. The method of claim 7, wherein
the RF tune away time is larger than the PDCP reordering time; and
the recovering the at least one out of order PDCP PDU comprises causing the RLC layer to send the plurality of RLC SDUs to a PDCP layer based on an RF tune-in irrespective of expiration of the PDCP reordering time.

10. The method of claim 7, wherein
the RF tune away time is unknown;
the method further comprises setting a PDCP reordering timer to the PDCP reordering time in response to detecting at least one out of order PDCP PDU; and
the recovering the at least one out of order PDCP PDU comprises:
terminating the PDCP reordering timer and storing a remaining time value of the PDCP reordering timer based on an RF tune away, and restarting the PDCP reordering timer with the remaining time value based on an RF tune-in, or
causing the RLC layer to send the plurality of RLC SDUs to a PDCP layer based on the RF tune-in irrespective of expiration of the PDCP reordering time.

11. The method of claim 1, further comprising:
causing, by the receiver, a PDCP layer to deliver old PDCP PDUs to a higher layer based on a difference between a PDCP state variable and a count of the old PDCP PDUs being lesser than or equal to a Sequence Number (SN) threshold, the old PDCP PDUs being PDCP PDUs received after expiration of a PDCP reordering timer.

12. The method of claim 1, further comprising:
setting, by the receiver, a PDCP reordering timer to the PDCP reordering time in response to detecting at least one out of order PDCP PDU; and
terminating, by the receiver, a process of initiating a PDCP reordering timer in response to detecting reception of at least one out of order PDCP PDU at a PDCP layer and reception of the plurality of RLC PDUs in a correct sequence at the RLC layer.

13. A receiver in a wireless communication system, the receiver comprising:
processing circuitry configured to,
detect at least one out of order radio link control (RLC) protocol data unit (PDU) in a plurality of RLC PDUs received from a transmitter,
perform a recovery action based on a Packet Data Convergence Protocol (PDCP) reordering time to recover the at least one out of order RLC PDU, and
cause an RLC layer to send a plurality of RLC service data units (SDUs) to a higher layer after performing the recovery action, the plurality of RLC SDUs corresponding to the plurality of RLC PDUs.

14. The receiver of claim 13, wherein
the PDCP reordering time is configured by the transmitter; or
the PDCP reordering time is based on at least one of a signal condition or a Transport Control Protocol (TCP) retransmission (RETX) timer value.

15. The receiver of claim 13, wherein the processing circuitry is configured to recover the at least one out of order RLC PDU via at least one of a Master Cell Group (MCG) bearer, a Secondary Cell Group (SCG) bearer, or a split bearer.

16. The receiver of claim 15, wherein the recovery action comprises:
initiating a RLC packet recovery timer, a value of the RLC packet recovery timer being set as a difference between the PDCP reordering time and a delta value, the delta value being at least one transmission time interval (TTI) for RLC status report delivery;
terminating the RLC packet recovery timer in response to receiving the at least one out of order RLC PDU; and
sending at least one RLC status report to the transmitter based on the at least one out of order RLC PDU not being received by expiration of the RLC packet recovery timer, the at least one RLC status report indicating an RLC acknowledgement (ACK) for the at least one out of order RLC PDU, and the sending the at least one RLC status report is performed according to channel conditions and irrespective of a status prohibit timer running status.

17. The receiver of claim 13, wherein the processing circuitry is configured to:
set a PDCP reordering timer to the PDCP reordering time in response to detecting at least one out of order PDCP PDU;
initiate a number of RLC status reports before expiration of the PDCP reordering timer, the number of RLC status reports being greater than or equal to ‘1’ and lesser than or equal to an integer factor of the PDCP reordering timer divided by a RLC reassemble timer;
send the number of RLC status reports to the transmitter before expiration of the PDCP reordering timer, the number of RLC status reports being sent to the transmitter irrespective of a status prohibit timer running status; and
send an RLC ACK for the at least one out of order RLC PDU to the transmitter in response to a failure to recover the at least one out of order RLC PDU based on sending the number of RLC status reports to the transmitter.

18. The receiver of claim 17, wherein the processing circuitry is configured to detect the at least one out of order RLC PDU in response to successful recovery of the at least one out of order RLC PDU based on sending the number of RLC status reports to the transmitter.

19. The receiver of claim 13, wherein
the receiver is included in a multiple-universal subscriber identity module (USIM) UE (MUSIM UE); and
the processing circuitry is configured to recover at least one out of order PDCP PDU based on Radio Frequency (RF) tune-away time and the PDCP reordering time.

20. The receiver of claim 19, wherein
the RF tune away time is smaller than the PDCP reordering time; and
the processing circuitry is configured to:
set a PDCP reordering timer to the PDCP reordering time in response to detecting at least one out of order PDCP PDU,
terminate the PDCP reordering timer and store a remaining time value of the PDCP reordering timer based on an RF tune away, and
restart the PDCP reordering timer with the remaining time value based on an RF tune-in.

21.-24. (canceled)
